(19) United States
(12) Patent Application Publication
(10) Pub. No.: US 2021/0295192 A1
(43) Pub. Date: Sep. 23, 2021

(54) METHOD FOR CALCULATING UNCERTAINTY OF DATA-BASED MODEL

(71) Applicant: M&D CO., LTD., Suwon-si, Gyeonggi-do (KR)

(72) Inventors: Jang bom CHAI, Seoul (KR); Kwang ho KIM, Suwon-si, Gyeonggi-do (KR); Hyun su KIM, Yongin-si, Gyeonggi-do (KR)

(73) Assignee: M&D CO., LTD., Suwon-si, Gyeonggi-do (KR)

(21) Appl. No.: 17/260,805

(22) PCT Filed: Nov. 8, 2018
(86) PCT No.: PCT/KR2018/013533

§ 371 Date: Jan. 15, 2021

(30) Foreign Application Priority Data
Jul. 20, 2018 (KR) 10-2018-0084658

(51) Int. Cl. G06N 7/00

(52) U.S. Cl. CPC G06N 7/005

(57) ABSTRACT

A method for calculating the uncertainty of a data-based model, includes: a memory data generation step (S10); a measurement data receiving step (S20); a Euclidean distance calculation step (S30); a kernel function calculation step (S40); a weighted area-specific effective number calculation step (S50) of calculating a weighted area-specific effective number (Nn); a weighted value setting step (S60) of setting a weighted area-specific weighted value (Wn); a total effective number calculation step (S70) of calculating a total effective number (Nt) according to a weighted value; a prediction data calculation step (S80) of calculating prediction data (Xq) about measurement data (Q); a weighted standard deviation calculation step (S90) of calculating a weighted standard deviation (Sw); and an uncertainty calculation step (S100) of calculating uncertainty (U) so as to determine the reliability of prediction data by means of the calculated uncertainty (U).

### CROSS-REFERENCE TO RELATED APPLICATION(S)

This application is a national entry of International Application No. PCT/KR2018/013533, filed on Nov. 8, 2018, which claims under 35 U.S.C. § 119(a) and 365(b) priority to and benefits of Korean Patent Application No. 10-2018-0084658, filed on Jul. 20, 2018 in the Korean Intellectual Property Office, the entire contents of which are incorporated herein by reference.

### TECHNICAL FIELD

The present invention relates to a method for calculating the uncertainty of a data-based model, and particularly to a method for calculating the uncertainty of a data-based model, which can increase the reliability of prediction data by calculating the uncertainty of the prediction data of the data-based model that monitors the drifts of sensors used in a nuclear power plant.

### BACKGROUND ART

At nuclear power plants, a number of sensors are installed for the purpose of improving drivability and guaranteeing safety, and thus signals which are acquired in real time are used to monitor power plant monitoring systems and protection systems by using a data-based model such as Auto Associative Kernel Regression (AAKR), Auto Associative Neural Network (AANN), Auto Associative Multivariate State Estimation Techniques (AAMSET), or the like.

The uncertainty of models that calculate prediction data by using a conventional data-based model was defined as a bias-variance of residuals calculated as a difference between the prediction data and measurement data measured from sensors. The 95% confidence interval of the distribution which is formed by the residual was applied and reflected in the prediction data of the model.

However, the conventional bias-variance of residuals has a problem in quantification because the residual distribution is formed differently depending on the measurement data, and in order to improve this, an alternative to increase the reliability of the uncertainty by the Monte-carlo method has been proposed.

The Monte-carlo method is a kind of a simulation method that obtains virtual results using random numbers, and may predict an average value for a system variable through iterative simulation and calculate a value for uncertainty.

The general procedure of the Monte-carlo method is as follows. First, a training dataset is created through sampling. Second, a prototype memory dataset is created. Third, the prediction data of a memory dataset is calculated as a test dataset. Fourth, the above steps as many times as desired are repeated. When the simulation process is completed through these steps, the prediction variance is evaluated by using the stored result and the bias is estimated to calculate the uncertainty.

However, in the case of the Monte-carlo method, there is a limitation in not considering the uncertainty of the prediction data when a drift occurs, since both when the drift occurs and when being in a steady state have the same uncertainty.

The Electric Power Research Institute (EPRI) issued Technical Report-104965 and submitted it to the U.S. Nuclear Regulatory Commission (USNRC) to obtain licensing in 2001, and presented requirements for quantifying the uncertainty of the algorithm being developed.

However, according to these requirements, the US Electric Power Research Institute (EPRI) conducted a study on the method for calculating the uncertainty of the model itself, but there is no method for calculating the uncertainty of the prediction data of a data-based model.

### DISCLOSURE

### Technical Problem

An object of the present invention is to provide a method for calculating the uncertainty of prediction data of a data-based model that monitors the drifts of sensors used in a nuclear power plant, so as to increase the reliability of the prediction data by means of the calculated uncertainty of the prediction data.

### Technical Solution

To achieve the above object, there is provided a method for calculating the uncertainty of a data-based model according to the present invention, the method comprising: a memory data generation step of generating pieces of memory data of M which is the number of states used in a data-based model, which is data of normal values output from a plurality of sensors when there are no drifts in the plurality of sensors; a measurement data receiving step of receiving and storing pieces of measurement data measured from the plurality of sensors; a Euclidean distance calculation step of calculating a Euclidean distance between the pieces of measured data for each of the pieces of memory data of M which is the number of states; a kernel function calculation step of calculating a kernel function using the Euclidean distance; a weighted area-specific effective number calculation step of split-plotting the kernel function calculated in the kernel function calculation step into a plurality of weighted areas split by an integer multiple of a kernel bandwidth determined by a user, determining whether the Euclidean distance calculated for each of the pieces of memory data of M which is the number of states is located in which one of the weighted areas, and calculating a weighted area-specific effective number which is the number of the pieces of memory data located in each weighted area; a weighted value setting step of setting a weighted area-specific weight for each of the weighted areas; a total effective number calculation step of calculating a total effective number according to a weighted value by multiplying, by the weighted area-specific weight, the weighted area-specific effective number calculated for each of the weighted areas, and summing the multiplied results; a prediction data calculation step of calculating prediction data for the measurement data using the kernel function and the M pieces of memory data; a weighted standard deviation calculation step of calculating a weighted standard deviation by receiving the prediction data, the pieces of memory data located for each of the weighted areas, a weight for each of the weighted areas, and the total effective number according to the weighted value; and an uncertainty calculation step of calculating uncertainty by multiplying, by the weighted standard deviation, a t-distribution value according to a reference reliability value determined by the user by using the total effective number according to the weighted value as a degree of freedom and determining the reliability of the prediction data by the calculated uncertainty.

### Advantageous Effects

The method for quantifying the uncertainty of a data-based model according to the present invention can increase the reliability of the prediction data by calculating the uncertainty of the prediction data of the data-based model that monitors the drift of each of sensors used in a nuclear power plant.

### BRIEF DESCRIPTION OF THE DRAWINGS

FIG. 1 is a flowchart illustrating a method for calculating the uncertainty of a data-based model according to the present invention.

FIG. 2 shows memory data when the number of sensors is three and the number of states of a signal is 100.

FIGS. 3A through 3C are views showing memory data for each of three columns of the memory data of FIG. 2.

FIG. 4 is a view showing 30 pieces of measurement data when the number of sensors is three.

FIGS. 5A through 5C show measurement data for each of three columns of the measurement data (Q) of FIG. 4, respectively.

FIG. 6 shows a Euclidean distance (di) for each of 100 pieces of memory data for the first measurement data.

FIG. 7 is a graph of a Gaussian kernel function according to Euclidean distances.

FIG. 8 is a diagram illustrating the weighted area-specific effective number for each of the weighted areas when a calculated Euclidean distance for the first measurement data is located in a certain area of the weighted areas.

FIG. 9 is a view showing t-distribution values according to degrees of freedom when the reliability is 95%.

FIG. 10A is a graph illustrating total effective numbers according to weighted values for all measured data.

FIG. 10B is a graph illustrating weighted standard deviations for all measured data.

FIG. 10C is a graph illustrating t-distribution values for all measured data.

FIG. 10D is a graph illustrating the uncertainty of all measurement data.

### BEST MODE FOR CARRYING OUT THE INVENTION

Hereinafter, a method for calculating the uncertainty of a data-based model according to the present invention will be described in detail with reference to the accompanying drawings.

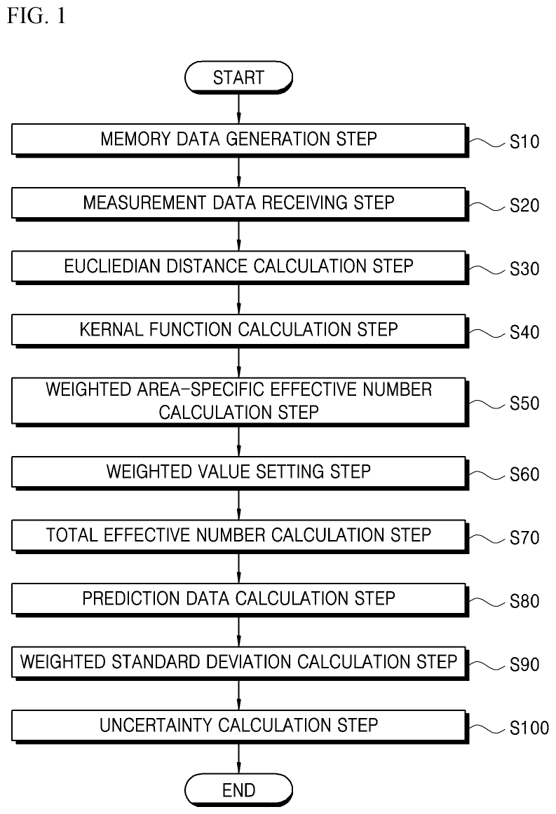

As shown in FIG. 1, the method for calculating the uncertainty of the data-based model according to the present invention, includes: a memory data generation step (S10) of generating pieces of memory data (X) of M which is the number of states used in a data-based model, which is data of normal values output from a plurality of sensors when there are no drifts in the plurality of sensors; a measurement data receiving step (S20) of receiving and storing pieces of measurement data (Q) measured from the plurality of sensors; a Euclidean distance calculation step (S30) of calculating a Euclidean distance (di) between the pieces of measured data (Q) for each of the pieces of memory data (X) of M which is the number of states; a kernel function calculation step (S40) of calculating a kernel function (K(di)) using the Euclidean di stance (di); a weighted area-specific effective number calculation step (S50) of split-plotting the kernel function (K(di)) calculated in the kernel function calculation step (S40) into a plurality of weighted areas (G1 to G7) split by an integer multiple of a kernel bandwidth (h) determined by a user, determining whether the Euclidean distance (di) calculated for each of the pieces of memory data (X) of M which is the number of states is located in which one of the weighted areas (G1 to G7), and calculating a weighted area-specific effective number (Nn) which is the number of the pieces of memory data (X) located in each of the weighted areas (G1 to G7); a weighted value setting step (S60) of setting a weighted area-specific weighted value (Wn) for each of the weighted areas (G1 to G7); a total effective number calculation step (S70) of calculating a total effective number (Nt) according to a weighted value by multiplying, by the weighted area-specific weighted value (Wn), the weighted area-specific effective number (Nn) calculated for each of the weighted areas (G1 to G7), and summing the multiplied results; a prediction data calculation step (S80) of calculating prediction data (Xq) for the measurement data (Q) using the kernel function (K(di)) and the M pieces of memory data (X); a weighted standard deviation calculation step (S90) of calculating a weighted standard deviation (Sw) by receiving the prediction data (Xq), the pieces of memory data (X) located for each of the weighted areas (G1 to G7), a weighted value (Wn) for each of the weighted areas, and the total effective number (Nt) according to the weighted value; and an uncertainty calculation step (S100) of calculating uncertainty (U) by multiplying, by the weighted standard deviation (Sw), a t-distribution value according to a reference reliability value determined by the user by using the total effective number (Nt) according to the weighted value as a degree of freedom and determining the reliability of the prediction data by means of the calculated uncertainty (U).

In addition, when there are a plurality of pieces of measurement data (Q) received in the measurement data receiving step (S20), the Euclidean distance calculation step (S30), the kernel function calculation step (S40), the weighted area-specific effective number calculation step (S50), the weighted value setting step (S60), the total effective number calculation step (S70) according to the weighted value, the prediction data calculation step (S80), the weighted standard deviation calculation step (S90) and the uncertainty calculation step (S100) are performed for each of the plurality of pieces of measurement data (Q).

In addition, in the weighted value setting step S60, the weighted value (Wn) is calculated by the following equation.

$${w}_{n} = \frac{K \{ ( n - \frac{1}{2} ) h \}}{K ( 0 )}$$

Here, n is an area number for each weighted area, K(0) is a Gaussian kernel function value when the Euclidean distance is zero, and h is a kernel bandwidth.

In addition, in the uncertainty calculation step (S100), the reference reliability value is 95%.

The operation of the method for calculating the uncertainty of the data-based model according to the above configuration of the present invention is as follows.

The memory data generation step (S10) generates pieces of memory data (X) of M which is the number of states used in a data-based model composed of pieces of normal value data output from the sensors when a number of sensors do not drift, that is, after the sensors have been calibrated.

The pieces of memory data (X) of M which is the number of states can be represented by an equation expressed in a matrix as follows.

$$X = [ \begin{matrix}{x}_{11} & … & {x}_{1 P} \\ ⋮ & ⋱ & ⋮ \\ {x}_{M} & … & {x}_{MP}\end{matrix} ]$$

In the above equation, P is the number of sensors, and M is the number of states of the memory data signal.

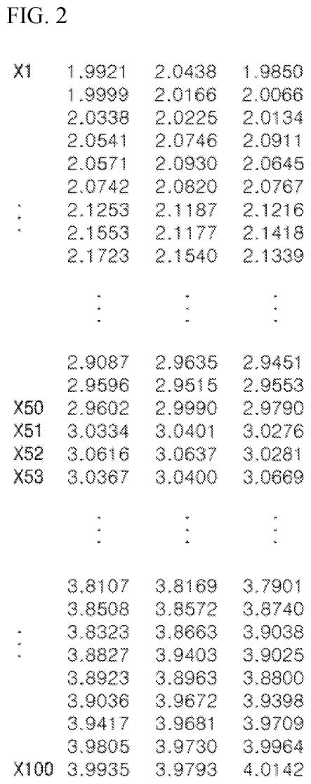

FIG. 2 shows the memory data (X) when the number of sensors (P) is three and the number (M) of states of the signal is 100, and the memory data (X) of FIG. 2 has 100 rows since the number (M) of the signal states is 100, and has three columns (AR1, AR2, AR3) obtained from these three sensors since the number of sensors (P) is three.

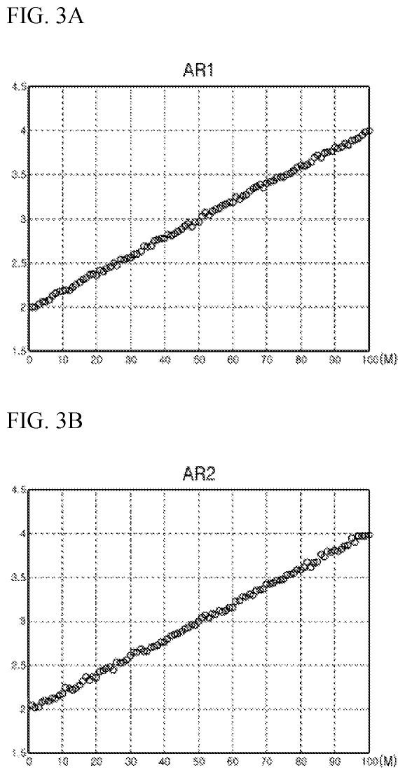

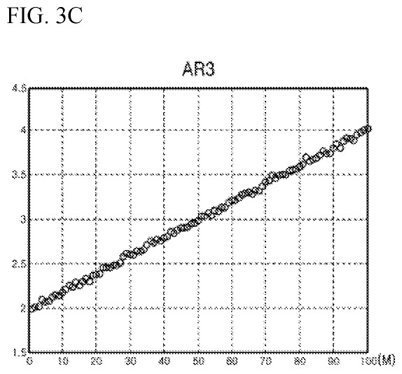

FIGS. 3A through 3C show respective pieces of memory data (X) for three columns (AR1, AR2, AR3) for the memory data (X) of FIG. 2.

The measurement data receiving step (S20) receives and stores pieces of measurement data (Q) measured from a plurality of sensors. That is, the pieces of the measurement data (Q) are values actually output from the sensors.

In this way, the pieces of the measured data (Q) measured from the plurality of sensors can be expressed by the following equation expressed in the following matrix.

Q=[q₁ . . . q_{P}]

In the above equation, P is the number of sensors.

The measurement data (Q) is a display of data measured at one point in time from a plurality of sensors, and by using the measurement data (Q) measured from the sensors at a plurality of points in time, an uncertainty (U), which will be described later, is calculated due to the drifts generated from the sensors, to thus determine the reliability of the prediction data (Xq).

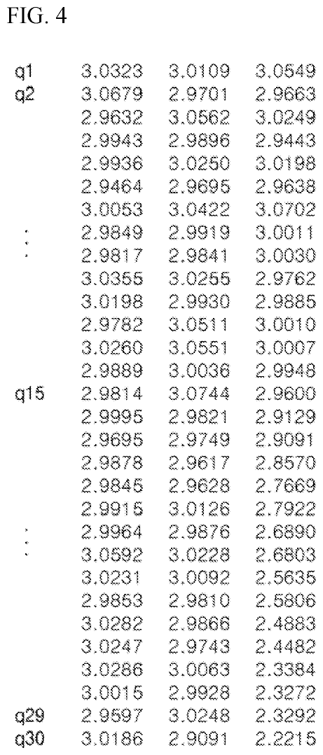

FIG. 4 is a view showing 30 pieces of measurement data (Q) when the number of sensors is three.

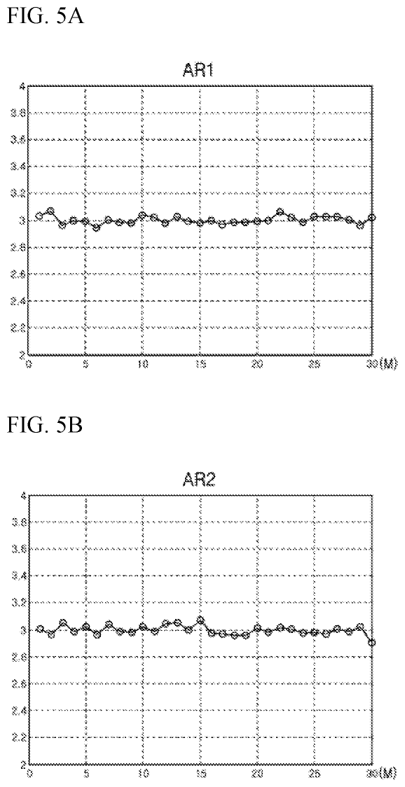

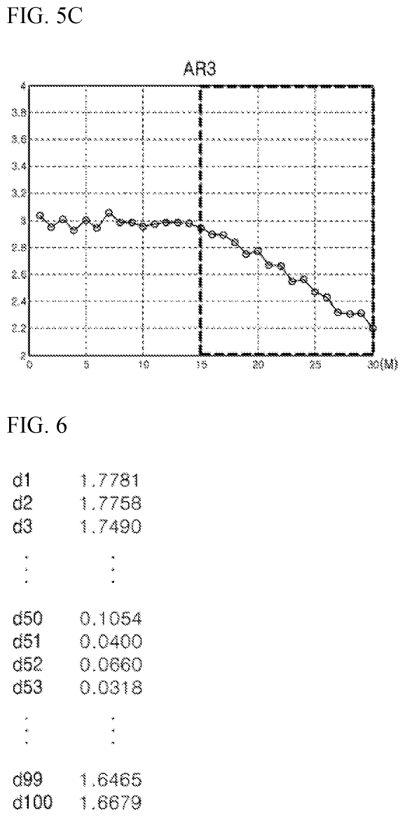

FIGS. 5A through 5C show respective measurement data (Q) for the three columns (AR1, AR2, AR3) of the measurement data (Q) of FIG. 4, and illustrate the cases in which a drift occurs from the 15th measurement data (Q15) to the 30th measurement data (Q30) only in the sensor corresponding to the third sensor (AR3) from among the three sensors.

In the Euclidean distance calculation step (S30), the Euclidean distance (di) between the pieces of the measurement data (Q) for each of the pieces of the memory data (X) of the M state number is calculated by the following equation.

$${d}_{i} = \sqrt{{\sum }_{j}^{P} {( {q}_{j} - {x}_{ij} )}^{2}}$$

The Euclidean distance (di) for one piece of measurement data (Q) calculated by the above equation can be expressed by the following matrix.

$${d}_{i} = [ \begin{matrix}{d}_{1} \\ ⋮ \\ {d}_{M}\end{matrix} ]$$

In the above equation, M is the number of states of the memory data signal.

For example, the Euclidean distance (d1) between the first memory data (X1) and the first measurement data (Q1) is calculated as follows.

Since the first memory data (X1) is [1.9921, 2.0438, 1.9850] and the first measurement data (Q1) is [3.0323, 3.0109, 3.0459], the first Euclidean distance (d1) is 1.7781, since the 51st memory data (X51) is [3.0334, 3.0401, 3.0276], and the first measurement data (Q1) is [3.0323, 3.0109, 3.0459], the 51st Euclidean distance (d51) is 0.0400, and since the 53rd memory data (X53) is [3.0367, 3.0400, 3.0669], and the first measurement data (Q1) is [3.0323, 3.0109, 3.0459], the 53rd Euclidean distance (d53) is 0.0318.

FIG. 6 is a view showing a Euclidean distance (di) for each of the pieces of the memory data (X) having a signal state number of 100 with respect to the first measurement data (Q1) through the above process.

The kernel function calculation step (S40) can calculate a kernel function (K(di)) by using various functions such as a Gaussian kernel, an inverse distance kernel, a square inverse distance kernel, an absolute exponential kernel, an exponential kernel, etc., which use a Euclidean distance (di), and when a representative Gaussian kernel function is used from among the various functions, the Gaussian kernel function (K(di)) is calculated by the following equation.

$$K ( {d}_{i} ) = \frac{1}{\sqrt{2 π {h}^{2}}} \text{?}$$

$$\text{?} \text{indicates text missing or illegible when filed}$$

In the above equation, h is the kernel bandwidth, and di is the Euclidean distance.

The kernel bandwidth (h) is a value determined by the user according to the memory data (X), and is a value related to the correlation between the measurement data (Q) and the memory data (X), and in the case of an embodiment of the present invention, the kernel bandwidth (h) is set to 0.0646.

The correlation between the measurement data (Q) and the M pieces of memory data (X) can be determined by the kernel function (K(di)) as described above.

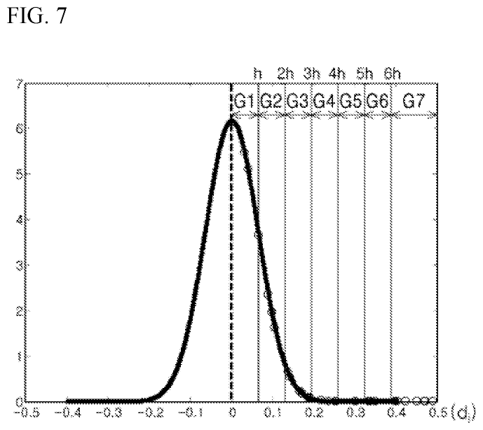

FIG. 7 is a graph of the Gaussian kernel function (K(di)) according to the Euclidean distance (di).

The weighted area-specific effective number calculation step (S50) split-plots the kernel function (K(di)) calculated in the kernel function calculation step (S40) into a plurality of weighted areas (G1 to G7) split by an integer multiple of a kernel bandwidth (h) determined by a user, determines whether the Euclidean distance (di) calculated for each of the pieces of memory data (X) of M which is the number of states is located in which one of the weighted areas (G1 to G7), and calculates a weighted area-specific effective number (Nn) which is the number of the pieces of memory data (X) located in each of the weighted areas (G1 to G7).

The Euclidean distance (di) of the Gaussian kernel function (K(di)) shown in FIG. 7 is split-plotted into a plurality of weighted areas (G1 to G7) split by integer multiples of the kernel bandwidth (h).

That is, as shown in FIG. 7, an area with 0<Euclidean distance (di)<1 h is split-plotted into a first weighted area (G1), and an area with 1 h<Euclidean distance (di)<2 h is split-plotted into a second weighted area (G2), an area with 2 h<Euclidean distance (di)<3 h is split-plotted into a third weighted area (G3), an area with 3 h<Euclidean distance (di)<4 h is split-plotted into a fourth weighted area (G4), an area with 4 h<Euclidean distance (di)<5 h is split-plotted into a fifth weighted area (G5), an area with 5 h<Euclidean distance (di)<6 h is split-plotted into a sixth weighted area (G6), and an area with 6 h<Euclidean distance (di)<7 h is split-plotted into a seventh weighted area (G7).

A number of weighted areas (G1 to G7) split by integer multiples of the kernel bandwidth (h) are expressed as the Gaussian kernel function (K(di)) as follows.

When n=1, 2, . . . , 5, or 6, K(nh)<Gaussian kernel function (K(di))<K((n−1)h), and when n=7, Gaussian kernel function (K(di))<K((n−1)h).

In the above equation, n denotes the number of each of the weighted areas (G1 to G7), and n=1 for the first weighted area (G1) and n=7 for the 7th weighted area (G7).

In addition, in the weighted area-specific effective number calculation step (S50), the number of weighted areas which are split-plotted is seven according to the embodiment of the present invention, but this is a value determined by a user.

The Gaussian kernel function (K(di)) is split-plotted into a plurality of weighted areas (G1 to G7) split by an integer multiple of a kernel bandwidth (h). Then, it is determined whether the Euclidean distance (di) calculated for each of the pieces of memory data (X) of M which is the number of states is located in which one of the weighted areas (G1 to G7), to then calculate a weighted area-specific effective number (Nn) which is the number of the pieces of memory data (X) located in each of the weighted areas (G1 to G7).

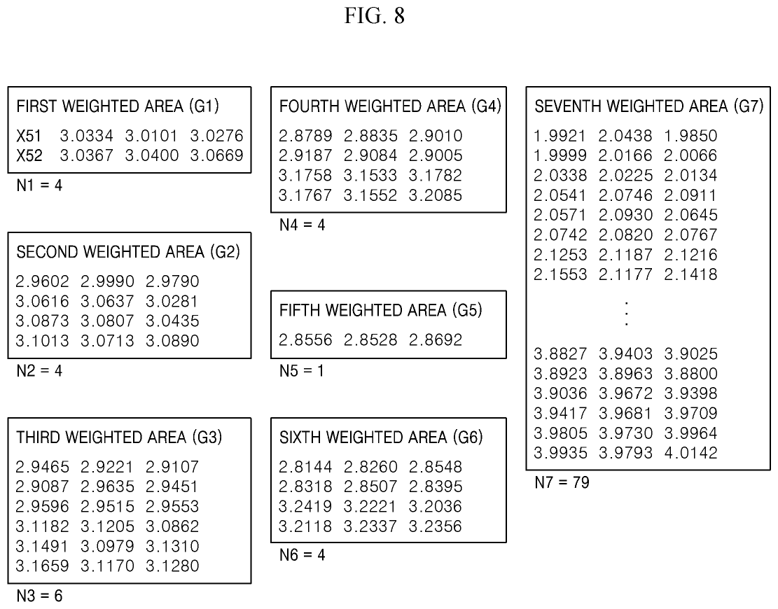

FIG. 8 shows whether the Euclidean distance (di) calculated for each of [3.0323, 3.0109, 3.0549] of the first measurement data (Q1) and 100 pieces of memory data (X) is located in which area of the weighted areas (G1 to G7), and shows the weighted area-specific effective number (Nn), which is the number of the pieces of the memory data (X) located in each of the weighted areas (G1 to G7).

For example, since the Euclidean distance (d51) of the 51st memory data (X51) from among 100 pieces of the memory data (X) by the Euclidean distance (di) shown in FIG. 6 is 0.0400, and the Euclidean distance (d53) of the 53rd memory data (X53) is 0.0318, it can be seen that [3.0334, 3.040, 3.0276] which is the 51st memory data (X51) and [3.0367, 3.0400, 3.0669] which is the 53rd memory data (X53) are located in the first weighted area (G1), and at this time, the effective number (N1) of the first weighted area, which is the number of the pieces of the memory data located in the first weighted area (G1), is two.

According to the above process, the effective number (N2) of the second weighted area (G2) is four, the effective number (N3) of the third weighted area (G3) is six, and the effective number (N4) of the fourth weighted area (G4) is four, the effective number (N5) of the fifth weighted area (G5) is one, the effective number (N6) of the sixth weighted area (G6) is four, and the effective number (N7) the seventh weighted area (G7) is 79.

In the weighted value setting step (S60), the weighted area-specific weighted value (Wn) for each of the weighted areas (G1 to G7) is set according to the following equation.

$${w}_{n} = \frac{K \{ ( n - \frac{1}{2} ) h \}}{K ( 0 )}$$

In the above equation, n denotes the area number of the weighted areas, and h denotes the kernel bandwidth.

The weighted value (Wn) for each weighted area corresponds to a value obtained by normalizing the median of the Gaussian kernel function (K(di)) of each weighted area to a Gaussian kernel function value (K(0)) when the Euclidean distance is zero.

According to the equation of the weighted value (Wn) for each weighted area, the weighted value (W1) of the first weighted area (G1) is K(0.5 h)/K(0) which is equal to 0.9394, and the weighted value (W2) of the second weighted area (G2) is K(1.5 h)/K(0) which is equal to 0.5698, the weighted value (W3) of the third weighted area (G3) is K(2.5 h)/K(0) which is equal to 0.2096, and the weighted value (W4) of the fourth weighted area (G4) is K(3.5 h)/K(0) which is equal to 0.0468, and the weighted value (W5) of the fifth weighted area (G5) is K(4.5 h)/K(0) which is equal to 0.0063, and the weighted value (W6) of the sixth weighted area (G6) is K(5.5 h)/K(0) which is equal to 5.1957×10^{-0.4}, and the weighted value (W7) of the seventh weighted area (G7) is K(6.5 h)/K(0) which is equal to 1.1254×10^{-0.7}.

The total effective number calculation step (S70) according to the weighted value calculates the total effective number (Nt) according to the weighted value by multiplying the weighted area-specific effective number (Nn) for each area calculated for the weighted areas (G1 to G7) by the weighted area-specific weighted value (Wn), and summing the multiplication results.

That is, when there are seven weighted areas, the total effective number (Nt) according to the weighted value is as follows.

$${N}_{t} = {\sum }_{n = 1}^{7} {w}_{n} {N}_{n} = {w}_{1} {N}_{1} + {w}_{2} {N}_{2} + {w}_{3} {N}_{3} + {w}_{4} {N}_{4} + {w}_{5} {N}_{5} + {w}_{6} {N}_{6} + {w}_{7} {N}_{7}$$

In the above equation, n denotes an area number of the weighted areas.

The total effective number (Nt) according to the weighted value is close to the memory data and measurement data based on the kernel function (K(di)), so that those with a short Euclidean distance have a relatively high effective number, and those with a long Euclidean distance have a relatively low effective number.

Therefore, according to the previously calculated effective numbers (N1 to N7) for each weighted area and weight values (W1 to W7) for the respective weighted areas, the total effective number (Nt) according to the weighted value for the first measurement data (Q1) is 0.9494×2+0.5698×4+0.2096×6+0.0468×4+0.0063×1+5.1957×10^{-0.4}×4+1.1254×10^{0.7}×79, which is equal to 5.6111.

The prediction data calculation step (S80) calculates prediction data (Xq) according to the following equation, in which prediction data (Xq) can be output from multiple sensors for measurement data (Q) by the previously calculated kernel function (K(di)) and M pieces of memory data (X).

$${X}_{q} = \frac{{\sum }_{i = 1}^{M} K ( {d}_{i} ) {X}_{i}}{{\sum }_{i = 1}^{M} K ( {d}_{i} )}$$

In the above equation, M denotes the number of states of the memory data.

Accordingly, the number of states is 100, and [3.0457, 3.0473, 3.0407], which is the prediction data (Xq) for [3.0323, 3.0109, 3.0549], which is the first measurement data (Q1), is calculated.

The weighted standard deviation calculation step (S90) receives the previously calculated prediction data (Xq), the memory data (X) located for the respective weighted areas (G1 to G7), the weighted value for each weighted area (Wn), and the total effective number (Nt) according to the weighted value, and calculates the weighted standard deviation (Sw) according to the following equation.

$${S}_{w}^{2} = \frac{{\sum }_{n = 1}^{7} {w}_{n} {\sum }_{k = 1}^{{N}_{n}} {( {X}_{nk} - {X}_{q} )}^{2}}{{N}_{t}}$$

In the above equation, n denotes the area number of each of the weighted areas, Nn denotes the effective number for each weighted area, Xnk denotes the memory data located for each weighted area, Xq denotes the prediction data, and Nt denotes the total effective number according to the weighted value.

In the first weighted area (G1), of which the area number is one from among the weighted areas (G1 to G7), [3.0334, 3.040, 3.0276] which is the 51st memory data (X51) and [3.0367, 3.0400, 3.0669] which is the 53rd memory data (X53) are located. Since the effective number (N1) of the first weighted area, which is the number of pieces of the memory data located in the first weighted area (G1), is two, the sum of squared errors the memory data (Xnk) for the first weighted area (G1) and prediction data (Xq) is [0.2315, 0.1032, 0.8591], and if pieces of the sum data are multiplied by 0.9394, which is the weighted value (W1) of the first weighted area (G1), data of [0.2175, 0.0969, 0.8071] is calculated.

By the above method, data is calculated for the second to seventh weighted areas (G2 to G7), respectively.

After summing the data calculated for the first weighted area (G1) to the seventh weighted area (G7), the summation result is divided by the total effective number (Nt) according to the weighted value, and the square root of this value is extracted, [0.0675, 0.0532, 0.0595], which is the weighted standard deviation (Sw) of the first measurement data (Q1), can be calculated.

When the distribution of the memory data (X) is located closer in comparison to the measurement data (Q), that is, the smaller the Euclidean distance (di) is, the larger the total effective number (Nt) according to the weighted value is relatively large. Therefore, the weighted standard deviation (Sw) decreases.

Conversely, when the distribution of the memory data (X) is located farther in comparison to the measurement data (Q), that is, the larger the Euclidean distance (di) is, the total effective number (Nt) according to the weighted values is relatively small. Therefore, the weighted standard deviation (Sw) increases.

The uncertainty calculation step (S100) calculates the uncertainty (U) by multiplying, by the weighted standard deviation (Sw), a t-distribution value according to a reference reliability value determined by the user by using the total effective number (Nt) according to the weighted value as a degree of freedom and determines the reliability of the prediction data by means of the calculated uncertainty (U).

In the case of a power plant, the reference reliability value requires 95%, so if the reliability is 95%, the uncertainty (U) is calculated by the following equation.

U=t_{c}(Nₜ,95%)×S_{w}

In the above equation, Nt denotes the total effective number according to the weighted value, and tc (Nt, 95%) denotes the t-distribution value according to 95% reliability by using the total effective number (Nt) according to the weighted value as a degree of freedom.

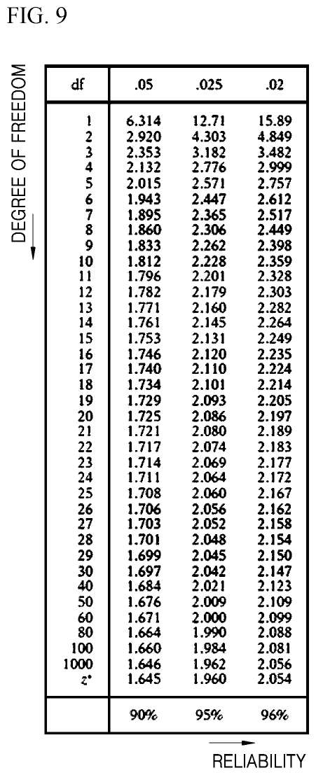

FIG. 9 is a diagram showing t-distribution values according to degrees of freedom when the reliability is 95%.

For example, in the case of the first measurement data (Q1), since the total effective number (Nt) according to the weighted value is 5.6111, as shown in FIG. 9, the degrees of freedom must be integers, so tc(6, 95%), which is the t-distribution of 6 having rounded up 5.6111 which is the total effective number (Nt) according to the weighted values, has 2.447.

Therefore, the uncertainty (U) for the first measurement data (Q1) is [0.0675, 0.0532, 0.0595]×2.447, which is the weighted standard deviation (Sw), so it has a value of [0.165, 0.131, 0.1455].

For all the measurement data (Q) shown in FIG. 4, the Euclidean distance calculation step (S30), the kernel function calculation step (S40), and the effective number calculation step (S50) for each weighted area, the weighted value setting step (S60), the total effective number calculation step (S70) according to the weighted value, the prediction data calculation step (S80), the weighted standard deviation calculation step (S90), and the uncertainty calculation step (S100) are performed according to the above method.

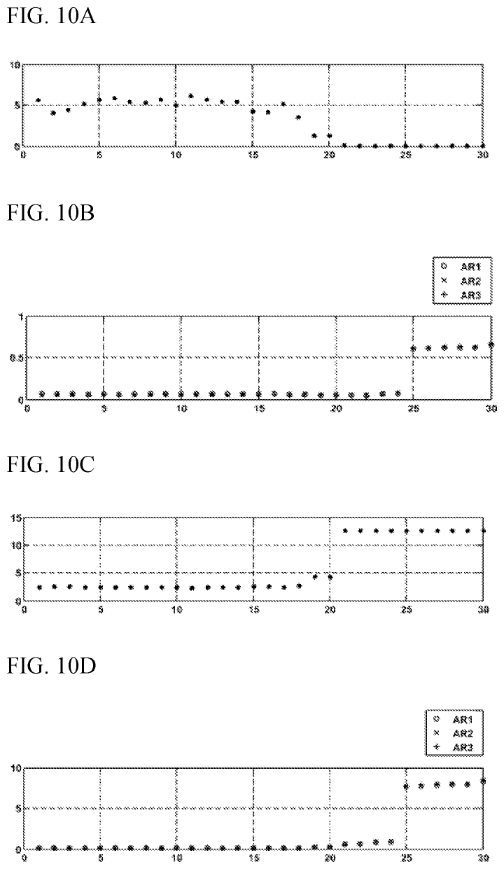

FIG. 10A is a graph showing the total effective number (Nt) according to the weighted value calculated through the total effective number calculation step (S70) according to the weighted value for each piece of measurement data of the 30 pieces of measurement data (Q) and 100 pieces of memory data (X) of FIG. 4. FIG. 10B is a graph showing the weighted standard deviation (Sw) calculated by the weighted standard deviation calculation step (S90) for each piece of measurement data of 30 pieces of measurement data (Q) and 100 pieces of memory data (X). FIG. 10C is a graph showing a t-distribution value according to the total effective number (Nt) according to the weighted value, and FIG. 10D is a graph showing the uncertainty (U) calculated through the uncertainty calculation step (S100).

As shown in FIG. 10A, when the correlation between the memory data (X) and the measurement data (Q) is high, that is, when the Euclidean distance (di) is small, the total effective number (Nt) has a relatively large value, and due to this, as shown in FIG. 10D, the uncertainty (U) has a relatively small value, indicating that the reliability of the prediction data is high.

However, when the correlation between the memory data (X) and the measurement data (Q) is low, that is, when the Euclidean distance (di) is large, the total effective number (Nt) according to the weighted value is relatively small. As a result, the uncertainty (U) has a relatively large value, indicating that the reliability of the prediction data is low.

For example, as shown in FIG. 4, when reviewing a case where a drift occurs in the third sensor, in the case of from the 15th measurement data (Q15) to the 30th measurement data (Q30) among the measurement data (Q), the total effective number (Nt) according to the weighted value has a relatively large value, in comparison to the total effective number (Nt) according to the weighted value of the pieces of measurement data (Q15 to Q30) after the drift has occurred in the case of from the first measurement data (Q1) to the 14th measurement data (Q14) before the drift occurs. As a result, the uncertainty (U) after the occurrence of the drift gradually increases, and then the uncertainty (U) for the 25th measurement data (Q25) suddenly increases. As a result, it can be seen that the reliability of the prediction data from the 15th measurement data (Q15) generated by the drift is gradually lowered.

What is claimed is:

1. A method for calculating the uncertainty of a data-based model, the method comprising:
a memory data generation step (S10) of generating pieces of memory data (X) of M which is the number of states used in the data-based model, which is data of normal values output from a plurality of sensors when there are no drifts in the plurality of sensors;
a measurement data receiving step (S20) of receiving and storing pieces of measurement data (Q) measured from the plurality of sensors;
a Euclidean distance calculation step (S30) of calculating a Euclidean distance (di) between the pieces of measured data (Q) for each of the pieces of memory data (X) of M which is the number of states;
a kernel function calculation step (S40) of calculating a kernel function (K(di)) using the Euclidean distance (di);
a weighted area-specific effective number calculation step (S50) of split-plotting the kernel function (K(di)) calculated in the kernel function calculation step (S40) into a plurality of weighted areas (G1 to G7) split by an integer multiple of a kernel bandwidth (h) determined by a user, determining whether the Euclidean distance (di) calculated for each of the pieces of memory data (X) of M which is the number of states is located in which one of the weighted areas (G1 to G7), and calculating a weighted area-specific effective number (Nn) which is the number of the pieces of memory data (X) located in each of the weighted areas (G1 to G7);
a weighted value setting step (S60) of setting a weighted area-specific weighted value (Wn) for each of the weighted areas (G1 to G7);
a total effective number calculation step (S70) of calculating a total effective number (Nt) according to a weighted value by multiplying, by the weighted area-specific weighted value (Wn), the weighted area-specific effective number (Nn) calculated for each of the weighted areas (G1 to G7), and summing the multiplied results;
a prediction data calculation step (S80) of calculating prediction data (Xq) for the measurement data (Q) using the kernel function (K(di)) and the M pieces of memory data (X);
a weighted standard deviation calculation step (S90) of calculating a weighted standard deviation (Sw) by receiving the prediction data (Xq), the pieces of memory data (X) located for each of the weighted areas (G1 to G7), a weighted value (Wn) for each of the weighted areas, and the total effective number (Nt) according to the weighted value; and
an uncertainty calculation step (S100) of calculating the uncertainty (U) by multiplying, by the weighted standard deviation (Sw), a t-distribution value according to a reference reliability value determined by the user by using the total effective number (Nt) according to the weighted value as a degree of freedom and determining the reliability of the prediction data by means of the calculated uncertainty (U).

2. The method according to claim 1, wherein when there are a plurality of pieces of measurement data (Q) received in the measurement data receiving step (S20), the Euclidean distance calculation step (S30), the kernel function calculation step (S40), the effective number calculation step (S50) for each weighted area, the weighted value setting step (S60), the total effective number calculation step (S70) according to the weighted value, the prediction data calculation step (S80), the weighted standard deviation calculation step (S90), and the uncertainty calculation step (S100), are performed for each of the plurality of pieces of measurement data (Q).

3. The method for claim 1, wherein in the weighted value setting step (S60), the weighted value (Wn) is calculated by the following equation.
$${w}_{n} = \frac{K \{ ( n - \frac{1}{2} ) h \}}{K ( 0 )}$$
where n denotes the number for each weighted area, K(0) denotes a Gaussian kernel function value when the Euclidean distance is zero, and h denotes a kernel bandwidth.

4. The method for claim 1, wherein a reference reliability value is 95% in the uncertainty calculation step (S100).
